(19) United States
(12) Patent Application Publication
(10) Pub. No.: US 2003/0220887 A1
(43) Pub. Date: Nov. 27, 2003

(54) Shipping shared services postage indicia

(76) Inventors: Vantresa Scott Stickler, Annapolis, MD (US); Paul J. Wanish, Poughkeepsie, NY (US); Richard A. Connell, Easton, MD (US); Pamela Morgan, Garrett Park, MD (US); Jonathan James Hurd, Lexington, KY (US); John Gullo, Alexandria, VA (US)

Correspondence Address: Ivan Mlachak, Lewis & Roca, LLP, 40 N. Central Ave., Phoenix, AZ, 85004, US

(21) Appl. No.: 10/298,622

(22) Filed: Nov. 15, 2002

Related U.S. Application Data
(60) Provisional application No. 60/335,605, filed on Nov. 15, 2001.

(51) Int. Cl. G06F 17/00

(52) U.S. Cl. 705/401

(57) ABSTRACT

A system and method is provided that enables a postal customer to order a shipping label on-line via the internet. The label may be a mailing label to be placed on letters or parcels. The label includes information such as postage, delivery address, return address, and a barcode for tracking delivery information. A user may request both a label and postage in what, to the user, appears to be a single computerized connection on a single internet web-page. A postage indicia is provided through a postage provider with whom the user has a deposit or credit. The label itself may be generated through a label-generating application hosted or generated by an entity separate from the postage provider.

### CROSS-REFERENCE TO RELATED APPLICATIONS

This application claims priority from U.S. Provisional Application No. 60/335605 filed on Nov. 15, 2001, entitled “Shipping Shared Services—Postage Evidencing Product.” The contents of the above applications are relied upon and expressly incorporated by reference as if fully set forth herein.

### STATEMENT REGARDING FEDERALLY SPONSORED RESEARCH OR DEVELOPMENT

The invention was made by an agency of the United States government or under a contract with an agency of the United States government, the United States Postal Service (“USPS” or “Postal Service”), an independent establishment of the executive branch of the U.S. government.

### BACKGROUND OF THE INVENTION

The invention relates generally to a method and system for providing an on-line application that allows shipment of domestic and international documents and packages. More particularly the invention relates to shipping labels and postage that authorize shipment.

### SUMMARY OF THE INVENTION

The United States Postal Service currently provides on-line services to Internet users through the USPS Web Tools system. These services enable e-tailers to embed USPS shipping functionality into their e-commerce web sites. These USPS services went into operation in August of 1999. Enhancements are continually being added. The on-line services offered as of December 2001 include track/confirm services, address checking, domestic and international postage rates, and shipping labels, among others.

The current USPS Web Tools system provides Application Program Interfaces (APIs) which allow developers of web-based and shrink-wrapped applications to gain access to these on-line services. In order to take advantage of these services, a software developer may visit the web site http://www.usps.com/shipping, click on the Web Tools link, and then Register for access to the APIs. Some of the resources provided by the USPS Web Tools system are web tool registration, documentation, XML code samples, resource links, and an XML test server. A registered user is assigned and e-mailed a uniquely generated user ID and password, which grants access to the programming documentation and the Web Tools system APIs.

One of the specific services that the USPS currently provides relates to labeling. The USPS allows a user to develop shipping labels with a return address delivery address, and a delivery confirmation barcode electronically via the USPS Shipping API system. The USPS Shipping API system provides software interfaces for accessing USPS shipping information over a network. The shipping information may include, but is not limited to, postal rates, mail tracking information, service standards, and issuance of delivery confirmation barcodes. The network is preferably the internet; however, any type of network known to those skilled in the art may be used. A delivery confirmation barcode includes information about the delivery point of a mailpiece and may be used to track the mailpiece in a mailstream.

In addition to the above-mentioned web tools, the USPS also authorizes postage vendors, such as PC Postage Vendors, to provide an IBIP (Indicia Based Information Program) or postage indicia electronically via the internet. The IBIP may be printed on, for example, an envelope or a label, to indicate postage payment. At present the IBIP is not seamlessly integrated into the other USPS web tools. A user who wishes to obtain postage electronically and who also wishes to access the available USPS electronic services must separately access these functionalities.

Postage cannot be sold on credit. Therefore a PC Postage Provider may offer the user the ability to charge a credit card and place the escrowed funds in a “Pre-Paid Postage Account”. Most providers charge a flat monthly fee for providing their services. For promotional purposes, some providers may give a modest amount of ‘free’ postage when registering with them. When the user buys Indicia, funds are drawn from the Pre-Paid Postage Account, and some providers add a surcharge onto the postage amount. The user adds funds to their Pre-Paid Postage Account by re-charging their credit card. Providers may be permitted to charge a minor percentage for refunded transactions, or a minor fee when an account is closed.

Users can perform additional functions, such as obtain the balance of their Pre-Paid Postage Account, obtain a transaction history, update their registration information, and/or close their Postage Provider account. Most of these transactions either involve the perusal of financial data or the direct movement of funds.

In general, the USPS Web Tools system should duplicate the overall utility of each of these financial transactions in order to accommodate the needs and expectations of both the consumer of the services and the Provider of the services. With that in mind, a number of modular components, APIs may be built onto the front-end of the Web Tools system to produce a Shipping Label With PC Postage, and to support its production.

The Postal Service will offer its customers an on line application that will allow them to ship domestic and international documents and packages via the internet. The application will include an XML over HTTPS indicia solution that can interact with the shipping application to be offered over www.usps.com.

Currently there are commercially available indicia solutions available that allow merchants and consumers to print postage on their shipping labels. For example, this can be accomplished through postage meters or with PC Postage. The drawback with these types of postage is that they can only be printed from the location where the physical device is. The present invention allows customers the ability to print labels with evidence of postage without the need of a postage device.

XL is not a product or a platform, but an enabling technology. SML is a standard for specifying a document markup language based on plain text tags and a data modeling language for markup languages in XML syntax. It is an open standard in that it is a subset of the Standard Generalized Markup Language (ISO 8879). Because of its flexibility, XML has been extended to address structured data types not covered by SGML. Hypertext Markup Language (HTML) is a similar tag-based cousin of XML, but where HTML tags tell the browser how to display various elements, XML tags specify what those elements are. XML tags identify content whereas HTML tags specify format.

The case for embracing X technologies offers certain advantages. XML is the basis for integrating data within an enterprise and across supply chains, substantially reducing the cost of information exchange. In addition to these enterprise application integration and business-to-business benefits, XML also greatly simplifies web-enabled business-to-consumer applications. In short an XML-enabled enterprise has a significantly lower cost structure for both development and maintenance of information systems. XML has become the basis of a plug-and-play e-business applications, information sharing, and electronic commerce. XML is fundamental to achieving the ability to adapt rapidly within the digital economy.

What XML does not provide is the mechanism to process data once received. When data arrives, some application needs to do something with it. USPS applications provide the necessary instructions to process XML data through scripting languages, such as Java, or high level programming tools. Java is often used to provide data manipulation and processing because of its widespread acceptance and availability.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claim. It is to be understood that both the foregoing general description and the following detailed description are exemplary and explanatory only and are not restrictive of the invention, as claimed. Thus, the present invention comprises a combination of features, steps, and advantages which enable it to overcome various deficiencies of the prior art. The various characteristics described above, as well as other features, will be readily apparent to those skilled in the art upon reading the following detailed description of the preferred embodiments of the invention, and by referring to the accompanying drawings.

### BRIEF DESCRIPTION OF THE DRAWINGS

For a more detailed description of a preferred embodiment of the present invention, reference will now be made to the accompanying drawings, which form a part of the specification, and wherein:

FIG. 1 is a flowchart that shows the steps for generating and distributing a label to a user through a shipping system.

FIG. 2 is a flowchart that shows the steps for generating and distributing a label to a user through a shipping system.

FIG. 3 is an example of XML programming that allows a user to order postage.

FIG. 4 displays a flowchart to obtain indicia from a provider.

FIG. 5 displays system capabilities of SSS.

FIG. 6 is a flowchart of the online label printing process.

FIG. 7 is a flowchart of the Express Mail and Priority Mail online label printing process.

FIG. 8 is a flowchart of the Global Express Guaranteed online label printing process.

FIG. 9 is a flowchart of the Global Express Mail online label printing process.

FIG. 10 is a flowchart of the Request for Online Refund process.

FIG. 11 is a flowchart of the online refund process for unused postage.

FIG. 12 is a flowchart of the online label monitoring process.

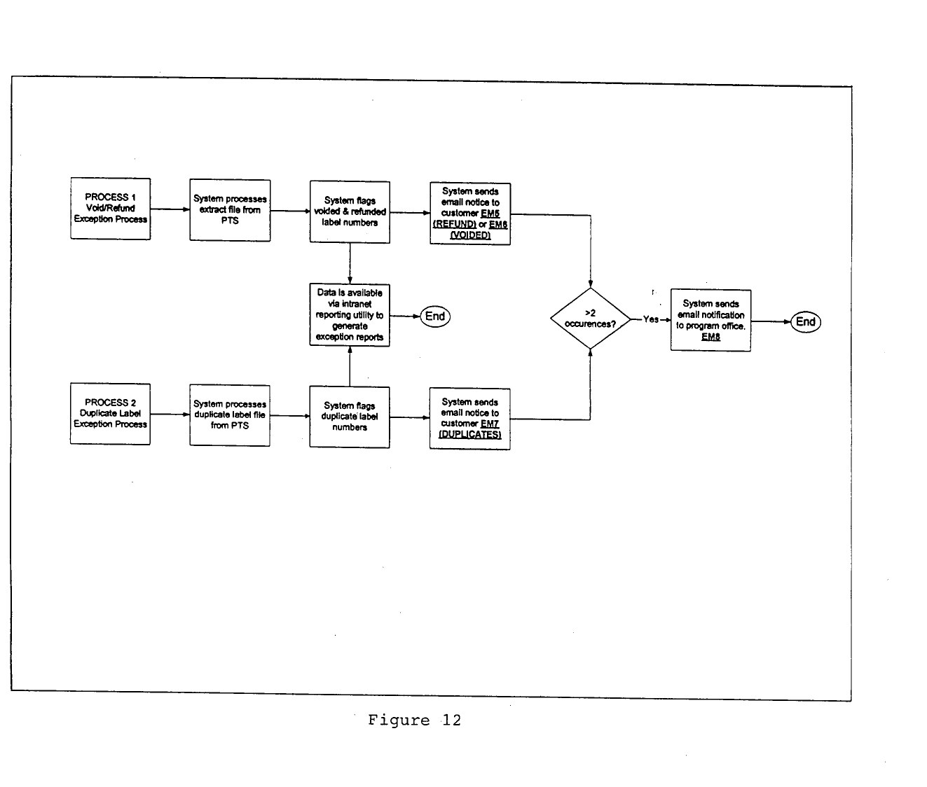

FIG. 13 is a flowchart of the priority mail mailing process.

FIG. 14 is a flowchart of the domestic and Global Express Mail mailing process.

FIG. 15 is a flowchart of the Global Express Guaranteed Mailing and Payment Process.

### DETAILED DESCRIPTION OF THE PREFERRED EMBODIMENT

Reference will now be made in detail to exemplary embodiments of the invention, examples of which are illustrated in the accompanying drawings. Wherever possible, the same reference numbers will be used throughout the drawings to refer to the same or like parts.

Customers can interact with an on-line application that will allow them to ship domestic and international documents and packages. The application is called Shipping Shared Services. The domestic and international shipping products available are Express Mail, Priority Mail, Global Express Guaranteed, Global Express Mail, and Package Services.

A customer or user upon requesting a shipping label through the Shipping Shared Services (SSS) platform receives an indicia image. The indicia image includes a 2 dimensional barcode and human readable elements. This information contains shipping information such as address information, shipping product, and postage.

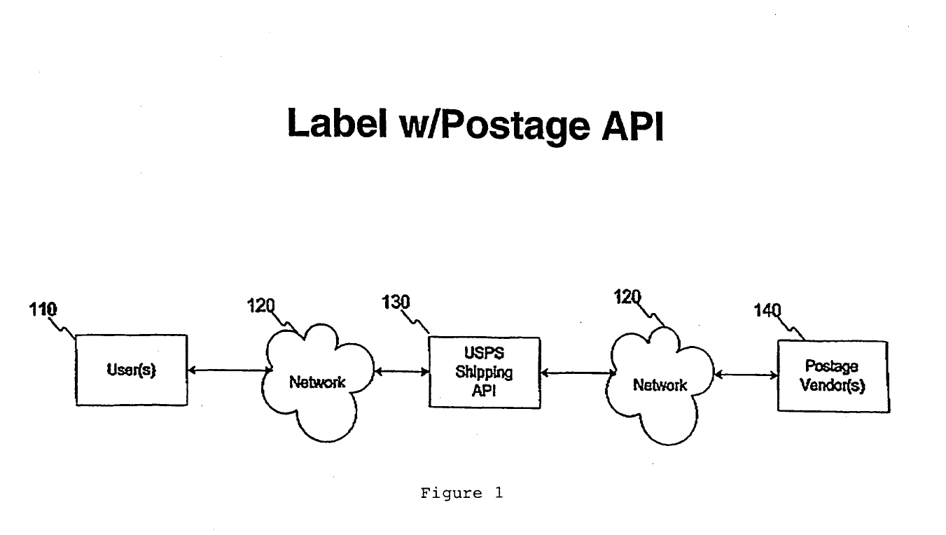

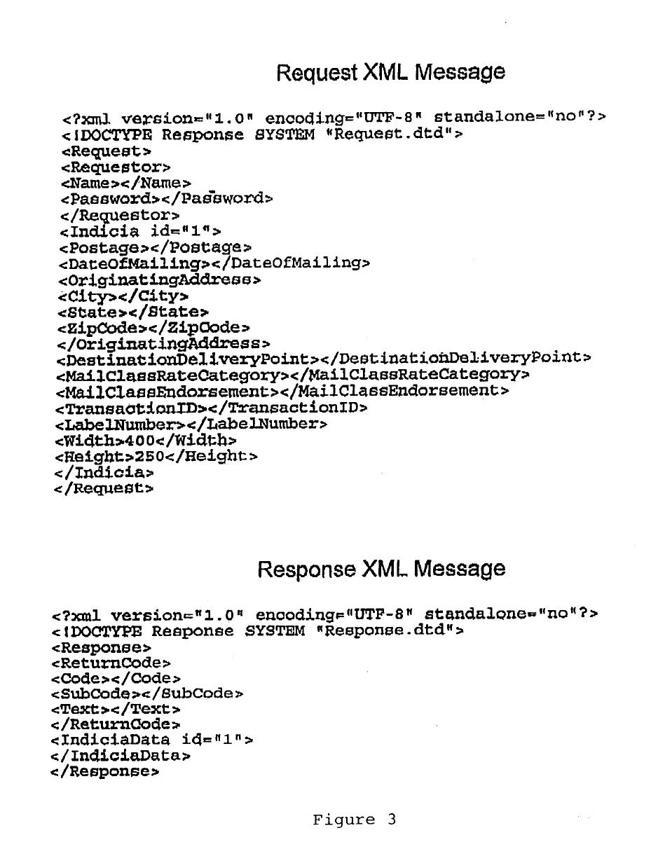

As shown in FIG. 3, communication between customer and the Postal Service application is through XML. A customer begins a transaction by submitting an XML message request. The response to the customer is also through XML. While FIG. 1 shows one kind of communication, other information may also be transmitted.

As shown in FIG. 1, a user 110 makes a request through a network 120 to a shipping system 130 for a label that includes address information, a postage indicia, and a delivery confirmation barcode. The request includes label information, for example, the name of the sender and/or a return address, the name and/or address of the recipient, and a mailing type for the label, such as Parcel Post, Express Mall, or Priority Mail. Optionally, the request may include the user's selection of a postage vendor 140, for example, VendorA, VendorB, or VendorC. The network 120 may include a Local Area Network (LAN), a Wide Area Network (WAN), a wireless network, the internet, and/or any other communication medium.

The shipping system 130 receives the request for the label and determines a postage rate. The shipping system 130 may include, for example, the USPS Shipping API system. Thereafter, the shipping system 130 sends the request and postage rate through the network 120 to a postage vendor 140 specified in the request. If no postage vendor 140 is specified in the request, the shipping system 130 selects a default postage vendor 140 and send the request and postage rate to the shipping system 130 and the postage vendor 140 are in the form of XML. However, other forms of communication may be used, such as HTML.

The postage vendor 140 debits a prepaid account for the postage rate and any additional associated label fee, and returns a postage indicia through the network 120 to the shipping system 130. The shipping system 130 requests and receives a delivery confirmation barcode from the USPS. Thereafter, the shipping system 130 generates the label based on the postage indicia, label information, and delivery confirmation barcode. The shipping system 130 may record the transaction. Finally, the shipping system 130 sends the generated label through the network 120 to the user 110.

In another embodiment, the shipping system is the USPS Shipping API system. A certified intermediary is an intermediary between the user and the shipping system. The certified intermediary may be a third party intermediary who is registered with the USPS and authorized to access the USPS Shipping API. The label with postage API provides software interfaces to third parties, such as the certified intermediaries, for communicating with the USPS Shipping API system. Alternatively, the certified intermediary may be a USPS Shipping Assistant. The USPS Shipping Assistant is a software application that provides software user interfaces, for example, a graphical user Interface, to provide shipping information to users. The shipping information may include, postal rates, mail tracking, service standards, issuance of delivery confirmation barcodes, information for tracking mailpieces, etc. The USPS Shipping Assistant is designed for users who want to use the USPS Shipping APIs but do not have the time or programming expertise and resources to integrate the USPS shipping API software interfaces into their systems or web sites.

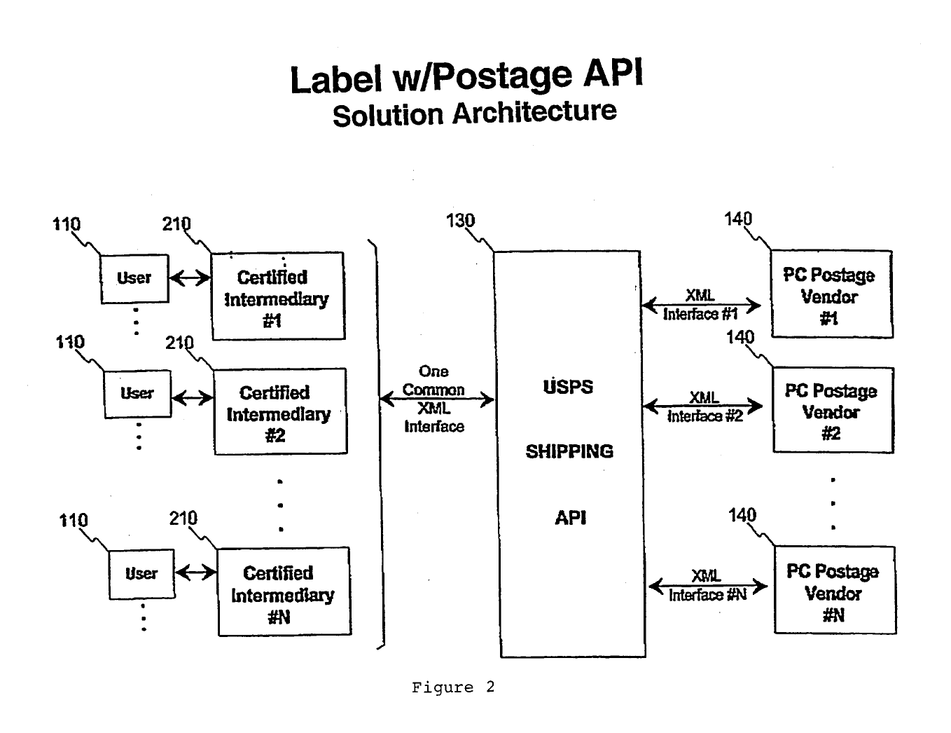

FIG. 2 shows one embodiment of a label with postage API system, which may be implemented in any combination of software and hardware components in accordance with the principles of the present invention. As shown in FIG. 2, a user 110 makes a request to a certified intermediary 210 for a label that includes postage and a delivery confirmation barcode. The request includes label information, for example, the name and address of the sender, the name and address of the recipient, and a mailing type for the label, such as Parcel Post, Express Mail, or Priority Mail. Optionally, the request may include the user's selection of a PC Postage vendor 140, for example, VendorA or VendorB. In a preferred embodiment, the PC postage vendors are postage vendors who have been authorized by the USPS to issue electronic postage. The certified intermediary 210 then sends the request to a shipping system 130, for example, the USPS Shipping API system. In a preferred embodiment, the certified Intermediary 210 and the shipping system 130 exchange Extensible Markup Language (XML) messages via a direct Transmission Control Protocol/Internet Protocol (TCP/IP) socket. However, the certified Intermediary 210 and the shipping system 130 may exchange HyperText Markup Language (HTML) messages using a HyperText Transfer Protocol (HTTP) or, in a wireless environment, may exchange Wireless Markup Language (WML) messages using a Wireless Application Protocol (WAP).

The shipping system 130 receives the request for the label and determines a postage rate. Thereafter, the shipping system 130 sends the request and postage rate to the PC Postage vendor 140 specified in the request. If no PC postage vendor 140 is specified in the request, the shipping system 130 selects a default PC Postage vendor 140 and sends the request and postage rate to the default PC Postage vendor 140. In a preferred embodiment, the shipping system 130 and the PC Postage vendor 140 exchange XML messages via a direct TCP/IP socket. However, the shipping system 130 and the PC Postage vendor 140 may exchange HTML messages using HTTP or, in a wireless environment may exchange WML messages using a WAP.

The PC Postage vendor 140 debits a prepaid account for the postage rate and any additional associated label fee, and returns a postage indicia to the shipping System 130. The shipping system 130 requests and receives a delivery confirmation barcode from the USPS. Thereafter, the shipping system 130 generates the label based on the postage indicia, label information, and delivery confirmation barcode. The shipping system 130 may record the transaction. Finally, the shipping system 130 sends the generated label to the certified intermediary 210 for distribution to the user 110.

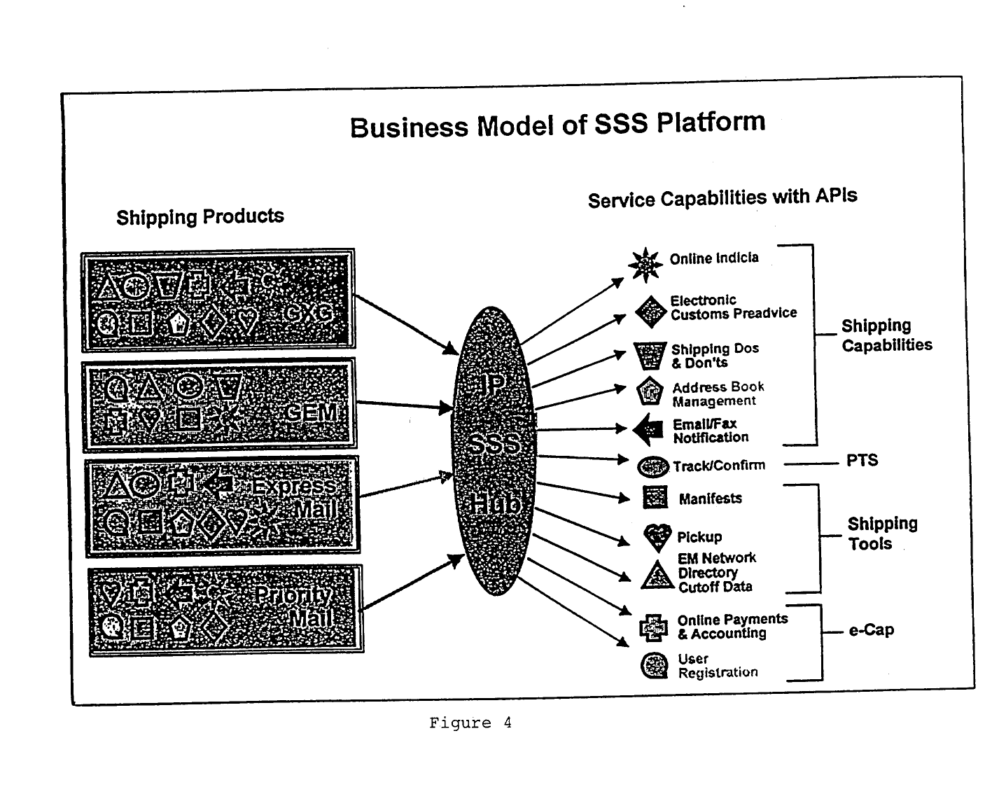

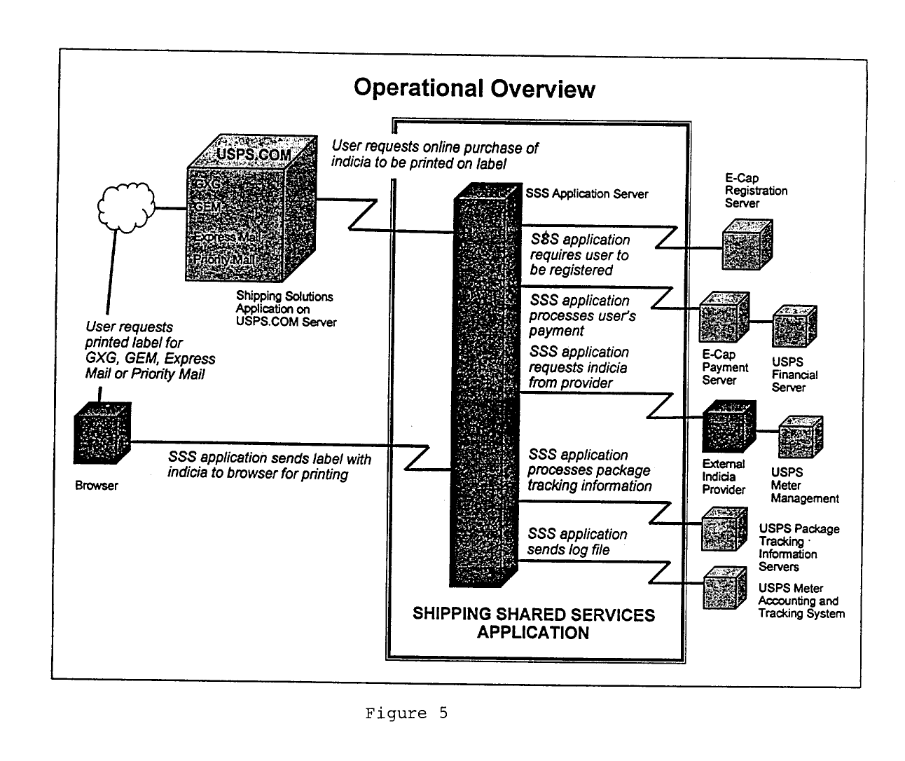

A specifically preferred embodiment of the Shipping Shared Services system is illustrated in FIGS. 4 and 5 and described below. This will be a transaction web site that will allow customers to print shipping labels online for domestic Express Mail (EM), Priority Mail (PM), Global Express Guaranteed (GXG), and Global Express Mail (GEM). This design provides the ability to add evidence of postage to the labels and to pay for the postage via credit card. The core of the architecture is the Shared Shipping Services (SSS) which provide the web-based infrastructure and application support services.

Referring now to FIG. 4, SSS includes the capability to obtain indicia from a provider currently approved by Postal Technology Management (PTM). SSS also includes the capability to process payment using credit cards and process USPS accounting for the charged amounts. For non-USPS entities selling postage online or from a postage meter, these functions are tested and approved by PTM. The SSS environment is being processed by PTM through the same testing and approval program to be permitted to function as an information-based indicia program (IBIP) offering.

The SSS system includes browser based mailer access. The mailer need not perform software downloads to use the services. There is no upfront or service maintenance payment. Credit card authorization takes place with each purchase. Indicia generation will be performed by a PTM approved indicia producer.

The SSS platform system components are depicted in FIG. 5. The browser's first access is to the usps.com server where a front-end Shipping solutions application runs. For informational requests, this is not required to be a secure session nor is the user required to register as an online user with the USPS.

The end user may choose to register as a USPS customer and will only register once for access to any USPS online offering. The registration session, where userid and password information is transmitted, is secured using 40 bit SSL.

If the end user is a mailer who chooses to purchase indicia online, the mailer will be required to use server authenticated 128 bit SSL to access the SSS secure Web server.

The mailer/purchaser is also required to provide userid and password, so the mailer/purchaser is authenticated to the eCap registration server to capture customer information.

The SSS web application enables mailers to enter address, dimension, and weight information, and produce mailing labels on their local printers.

The purchaser of indicia must pay for postage using a credit card. The eCap payment server handles credit card processing. An external provides through SSS provides postage in the form of an indicium. The SSS then sends the label with indicia to the customer browser for printing.

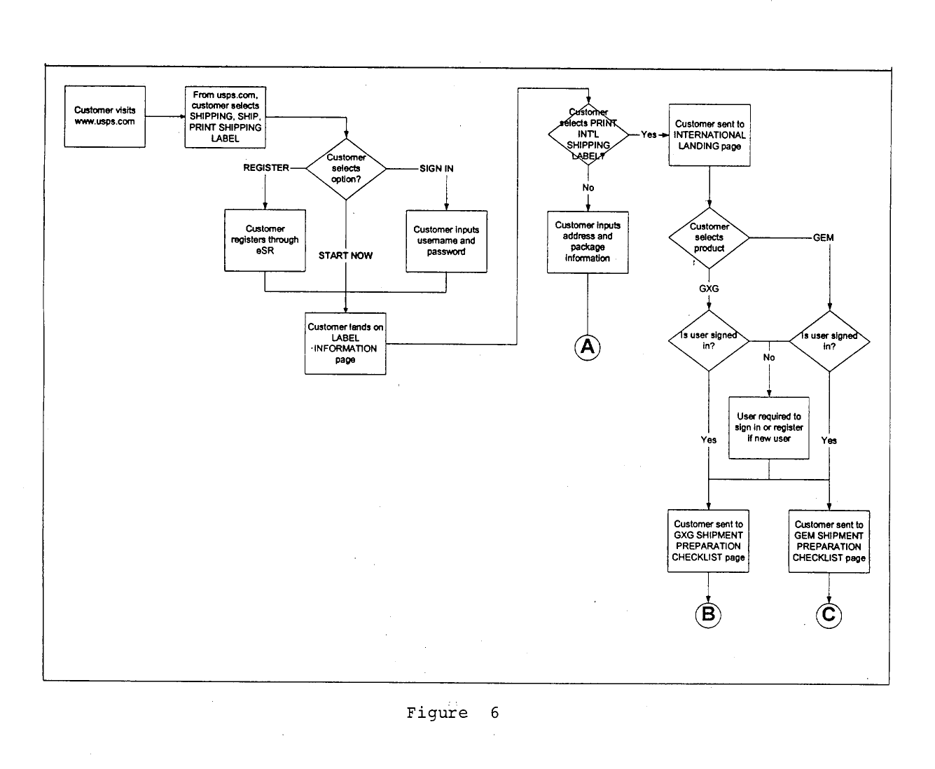

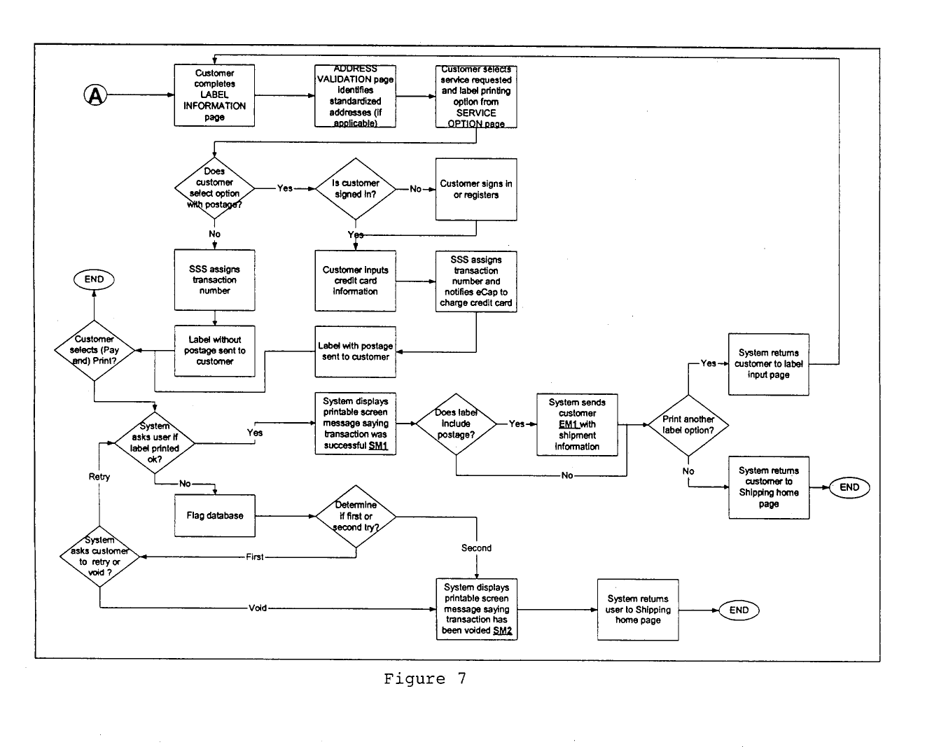

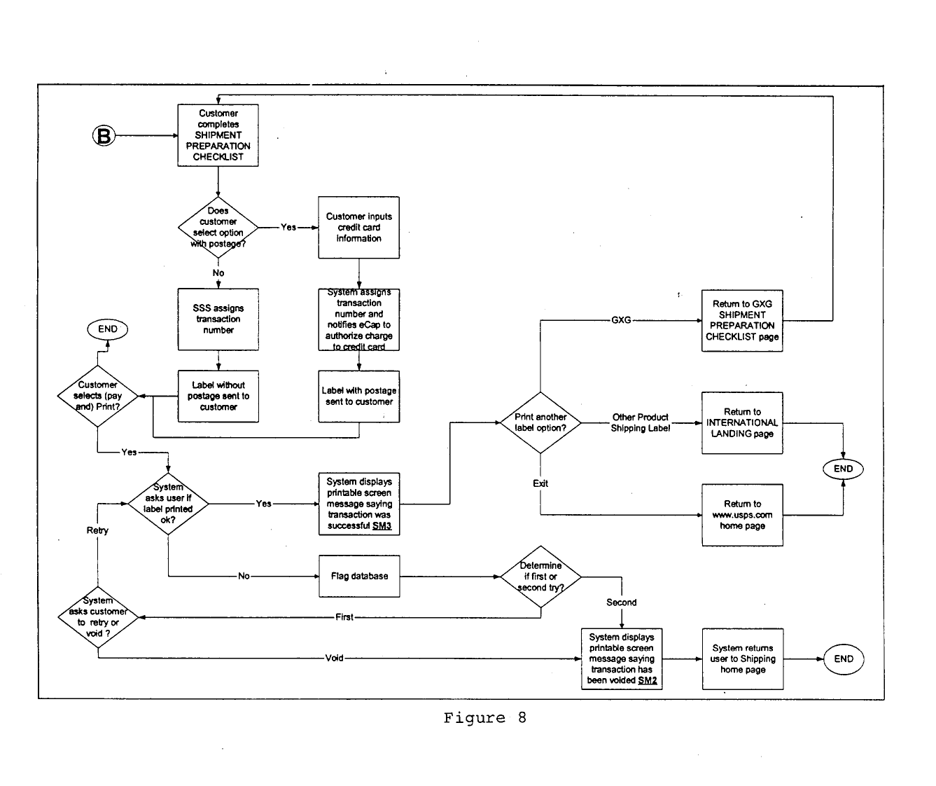

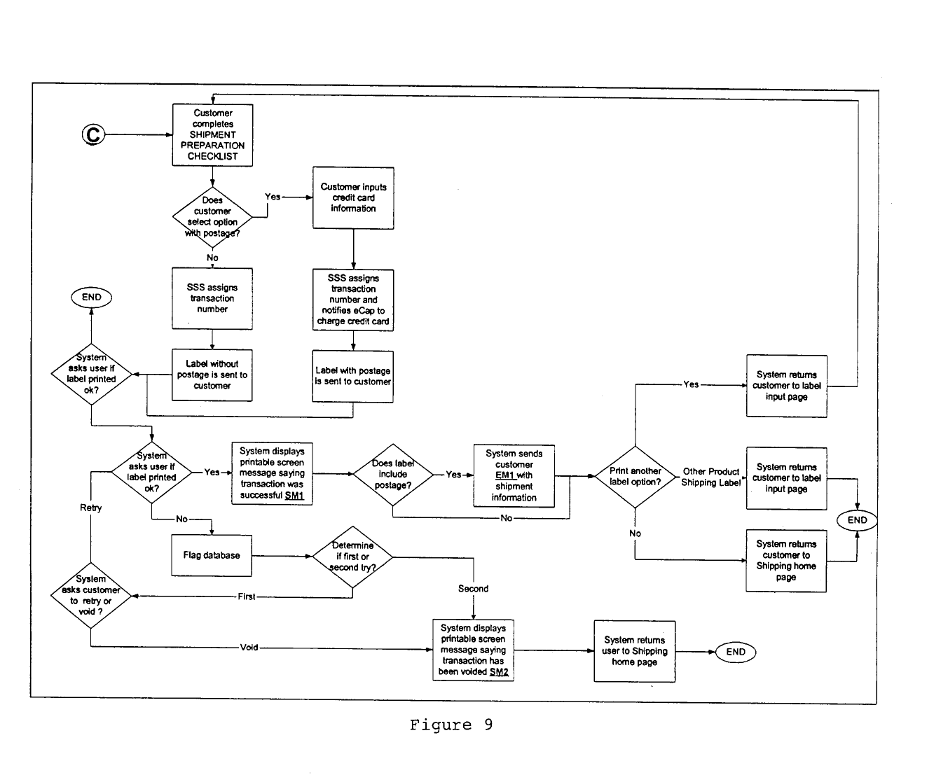

FIGS. 6 through 9 present a flow chart for the online label printing process. The user visits www.usps.com, selects the Shipping site, and completes the label printing and payment requirements. He/she selects “Print and pay” and successfully prints a label with postage. Notification is made to eCap to provide a unique authorization number and charge the postage amount to the user's credit card. The user confirms the successful printing of the label through a message screen. When the user confirms the printing was successful, an email is created and sent to the user with detailed information on the transaction. After successfully printing the label, the user has the option to print another label or return to the shipping home page. If the label printing is unsuccessful, the user is allowed a second try.

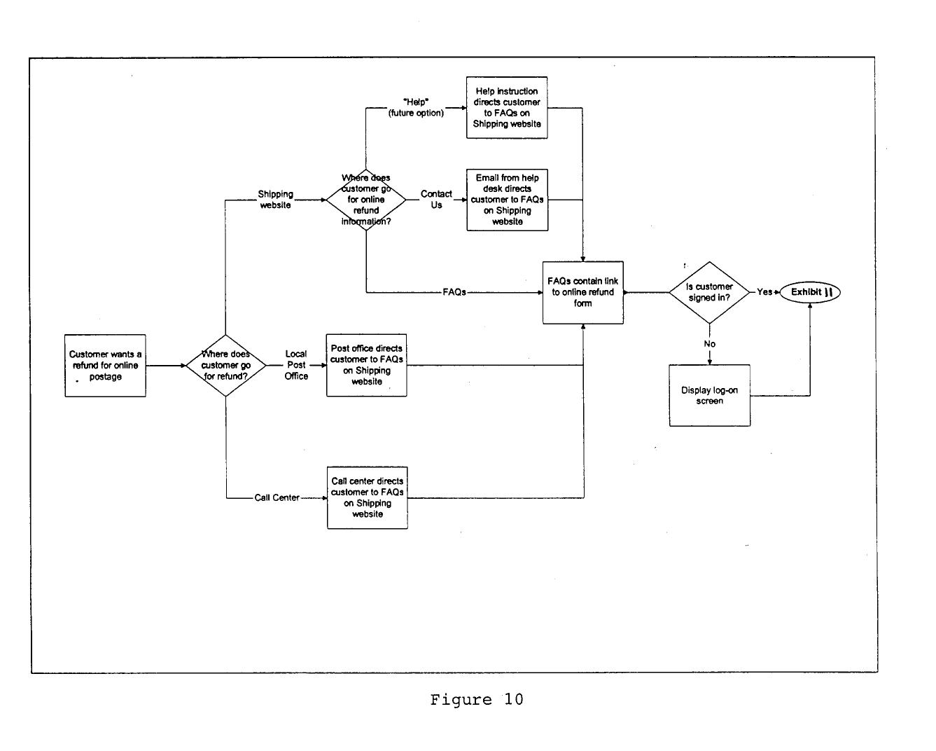

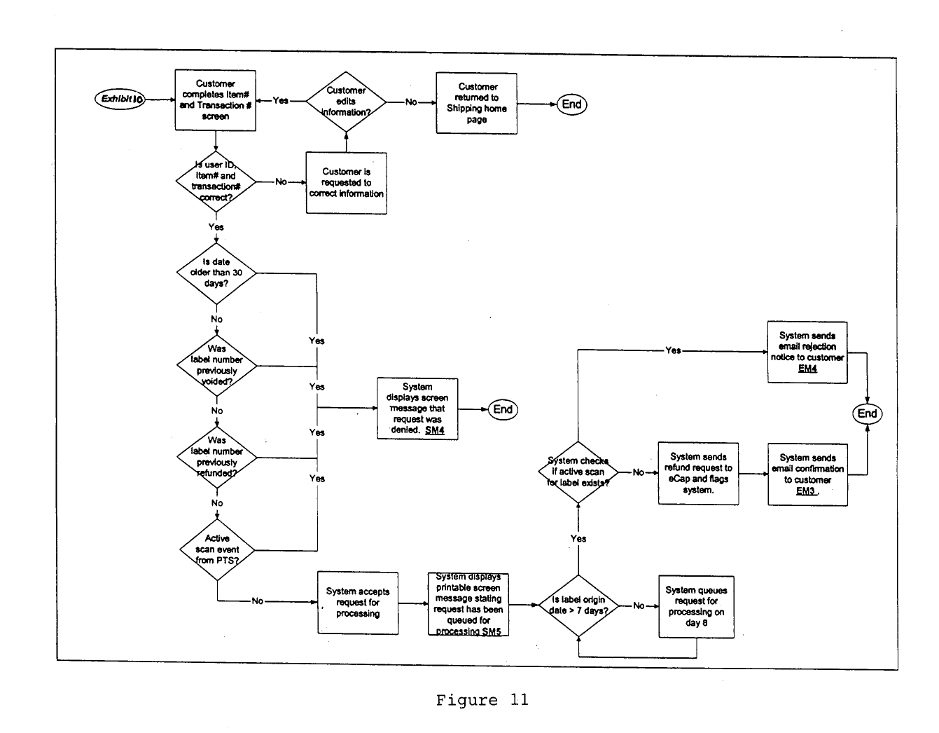

FIGS. 10 and 11 show the refund process if the user does not use the label. The user may choose the “Contact Us” selection, the FAQ's or the “Help” selection on the Shipping web site. All inquiries will result with the user being directed to a FAQ on how to request a refund. The FAQ page further contains a link to the refund page. If the user is not currently logged in, he will be required to do so.

The online refund process for unused postage requires the user to input valid matching shipment and transaction numbers. If the numbers do not match the SSS database an error message is displayed to the user, and they may edit the information or exit to the shipping home page. Matching numbers authorize the system to perform a series of validation checks to qualify the request. A valid request for a label printed at least seven days prior, the request is queued for processing and a screen message is displayed to the user. A valid request for a label printed less than seven days prior, the request is placed in a pending file until the seven days expire since the printing of the label. In this scenario, a screen message informs the user when the request will be processed.

As shown in exhibit 12 SSS monitors to identify label discrepancies that may indicate fraud or abuse. Specifically, this process will look for label tracking numbers that meet one or more of the following descriptions: voided labels where the user has confirmed that the label was never produced at the initial label printing process; unused labels with evidence of postage where the user has previously requested a refund; and duplicate use of a label with evidence of postage where a user has in some fashion made a copy of the original label and reused it.

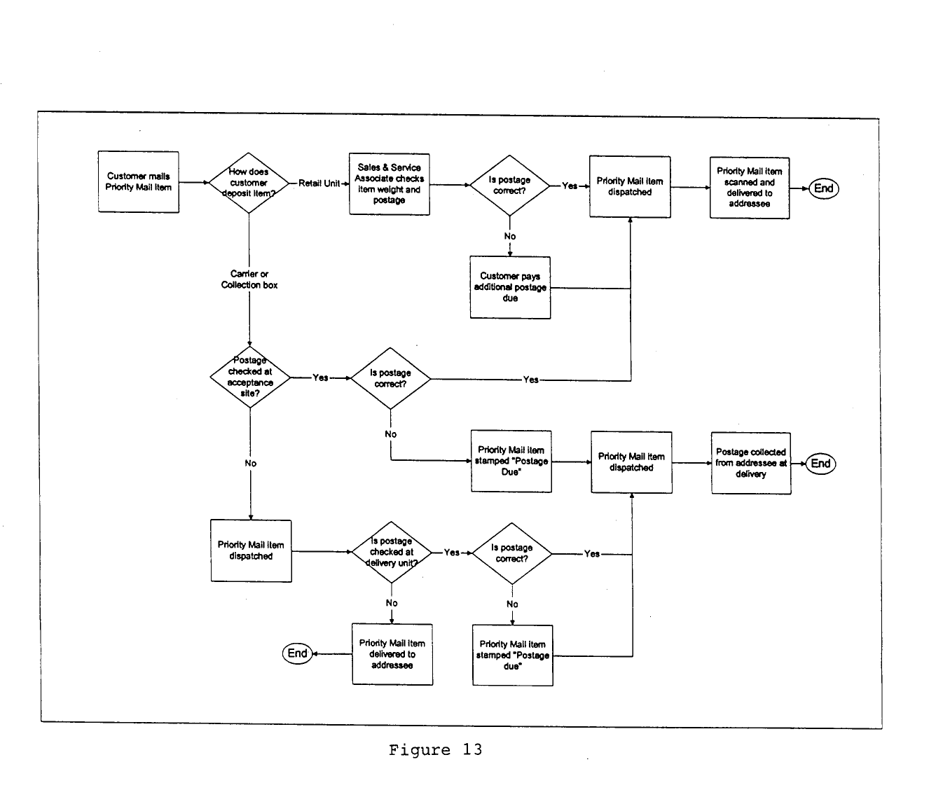

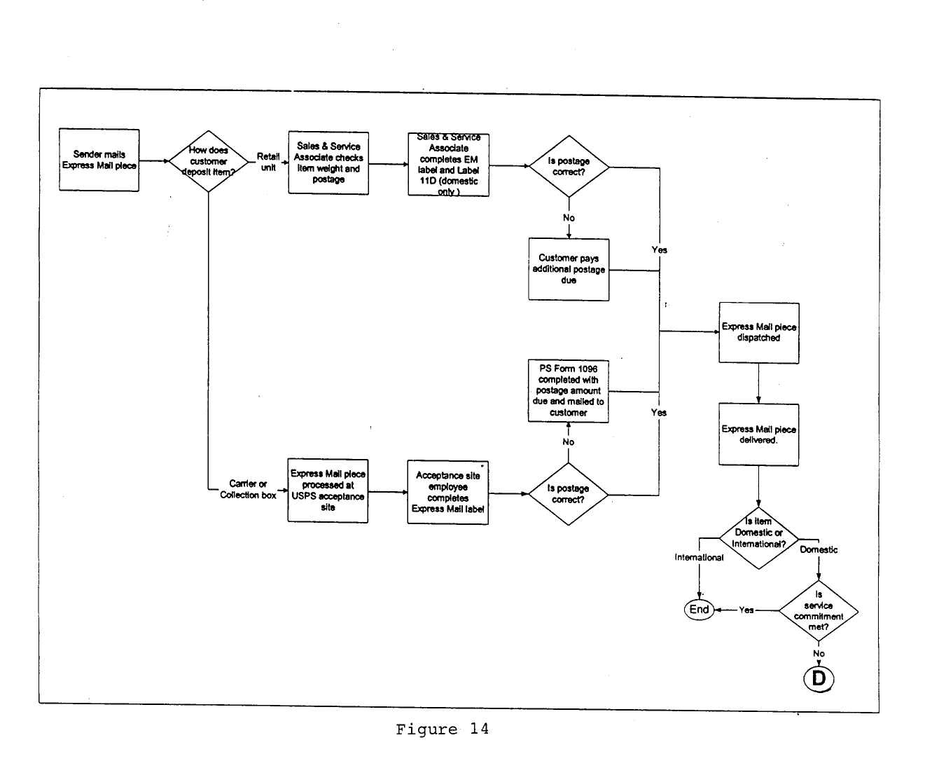

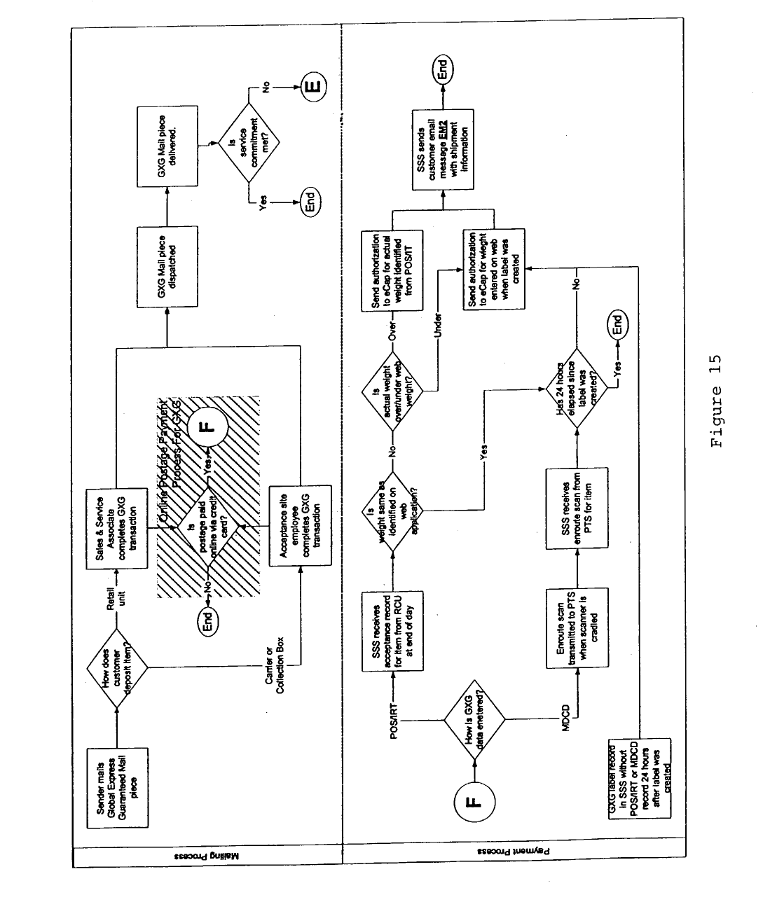

FIGS. 13, 14, and 15 show optional but preferred procedures for handling Priority Mail, Global Express Mail, and Global Express Guaranteed Mail.

The system and method that have been described may be comprised of a variety of hardware and software packages. From the standpoint of the user, the particular hardware or software package required may depend on the requirements necessary to interact with the certified intermediary. Where, for example, the certified intermediary is a company shipping department, the connection between the user and certified intermediary may be through an intranet system or other network. However, the system is also designed such that connections over the internet may also provide the needed connection. The shipping label with postage system will operate on commonly-used operating system such as Microsoft Windows and LINUX.

While preferred embodiments of this invention have been shown and described, modifications thereof can be made by one skilled in the art without departing from the spirit or teaching of this invention. The embodiments described herein are exemplary only and are not limiting. Many variations and modifications of the system and apparatus are possible and are within the scope of the invention. One of ordinary skill in the art will recognize that the process just described may easily have steps added, taken away, or modified without departing from the principles of the present invention. Accordingly, the scope of protection is not limited to the embodiments described herein, but is only limited by the claims which follow, the scope of which shall include all equivalents of the subject matter of the claims.

What is claimed is:

1. A method for providing a shipping label to a user, wherein the label includes a postage indicia and a delivery confirmation barcode, the method comprising:
receiving a request for the label, wherein the request includes label information;
determining a postage rate;
sending the request and postage rate to a postage vendor;
debiting, by the postage vendor, a prepaid account for the postage rate and any associated label fee;
receiving a postage indicia from the postage vendor;
requesting a delivery confirmation barcode;
receiving the requested delivery confirmation barcode;
generating the label based on the postage indicia, label information, and delivery confirmation barcode; and
sending the generated label to the user.

2. The method of claim 1, wherein the step of receiving a request for the label comprises a step of receiving the request for the label from an intermediary.

3. The method of claim 1, wherein the step of receiving a request for the label comprises a step of receiving the request for the label from the user.

4. The method of claim 1, further comprising the step of recording the transaction.

5. The method of claim 1, wherein the label information includes a recipient address.

6. The method of claim 1, wherein the label information further includes a recipient name.

7. The method of claim 1, wherein the label information further includes a return address.

8. A computer system for providing a postage label to a requester where the label has both address information and postage, comprising
a user computer,
an intermediary computer capable of being linked to said user computer by a network, and
a postage provider computer capable of being linked to said intermediary computer by a network.

9. The computer system of claim 8 further comprising a web page through which the reqeuster requests both the address and the postage for the label.

10. The computer system of claim 8 wherein the network linking the user computer and the intermediary computer is a local area network.

11. The computer system of claim 8 wherein the network linking the intermediary computer and the postage provider computer is the internet.

12. The computer system of claim 8 further comprising a shipping system computer capable of being linked to said intermediary computer by a network and wherein said shipping system computer and said intermediary computer exchange extensible markup language messages via a direct transmission control protocol/internet protocol socket.

13. The computer system of claim 12 wherein the address for the label is generated through a shipping assistant software application provided by said shipping system computer.

14. A shipping system for providing postage label information among computers comprising:
at least one intermediary computer sending information including a postage request to a shipping system computer,
said shipping system computer sending information, including a postage rate, to a postage provider computer;
said postage provider computer sending information, including a postage indicia to said shipping system computer; and
said shipping system computer sending information, including said postage indicia to said intermediary computer.

15. The shipping system of claim 14 further comprising the step of said shipping system computer selecting said postage provider computer with which to communicate from a list of postage providers.

16. The shipping system of claim 15 wherein said postage provider computer selects said postage provider computer from information received from said intermediary computer.

17. The shipping system of claim 14 further comprising the step of said shipping system computer determining said postage rate.

18. The shipping system of claim 14 further comprising the step of said postage provider computer issuing said postage indicia.

19. The shipping system of claim 14 wherein said intermediary computer, said shipping system computer, and said postage provider computer exchange information via XML messages, HTML messages, or WML messages.

20. The shipping system of claim 14 further comprising a plurality of intermediary computers exchanging information with said shipping system computer via a single XML interface.
